(19) United States
(12) Patent Application Publication
(10) Pub. No.: US 2009/0040167 A1
(43) Pub. Date: Feb. 12, 2009

(54) PROGRAMMABLE NONVOLATILE MEMORY EMBEDDED IN A TIMING CONTROLLER FOR STORING LOOKUP TABLES

(76) Inventor: Wein-Town Sun, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/965,713

(22) Filed: Dec. 27, 2007

Related U.S. Application Data
(60) Provisional application No. 60/954,024, filed on Aug. 6, 2007.

(51) Int. Cl. G09G 3/36

(52) U.S. Cl. 345/99

(57) ABSTRACT

A timing controller in an LCD has an OTP memory—a one time programmable nonvolatile memory or a MTP memory—a multiple time programmable nonvolatile memory embedded in for storing lookup tables of overdrive functions, dynamic contrast adjustments, independent RGB Gamma curve corrections, and data conversion of cyclic DAC functions. The logic process of the OTP memory and the logic process of the timing controller are completely compatible, and the logic process of the MTP memory only needs two or three photomask processes more than the logic process of the timing controller.

### CROSS REFERENCE TO RELATED APPLICATIONS

This application claims the benefit of U.S. Provisional Application No. 60/954,024, filed on Aug. 6, 2007 and entitled “Neobit Application to Tcon of LCD Displays”, the contents of which are incorporated herein by reference.

### BACKGROUND OF THE INVENTION

1. Field of the Invention

The present invention relates to a timing controller in an LCD for processing image data, especially to a timing controller in which a programmable nonvolatile memory is embedded for storing lookup tables.

2. Description of the Prior Art

As the advanced development in technology, the display panels of personal computers or televisions have become larger in size, but lighter in weight and thinner in thickness. Therefore more and more entertainment systems use liquid crystal displays (LCDs) to replace cathode ray tubes (CRTs).

Please refer to FIG. 1. FIG. 1 is a diagram of the structure of an LCD 100 according to the prior art. The LCD 100 includes a timing controller 101, a panel power supply 102, an external memory DRAM 103, a serial EEPROM 104, column drivers 105, an LCD panel 106, Row drivers RD 107, and a DAC reference voltage generator 109. The timing controller 101 is for performing timing control functions of the LCD 100, the external memory DRAM 103 is for storing the previous image for the timing controller 101, and the serial EEPROM 104 is for storing the lookup tables for the timing controller 101. The panel power supply 102 is for supplying the power for the LCD 100. The column drivers 105 and the row driver RD 107 are for driving pixels (shown in FIG. 2) of the LCD 100. The column drivers 105 are for transmitting data to the pixels and the RD 107 are for enabling the pixels. The LCD panel 106 is for representing the images of frames, and the DAC reference voltage generator 109 is for supplying the reference voltage for the gamma curve.

Please refer to FIG. 2. FIG. 2 is the schematic drawing of a pixel 201 according to the prior art. The pixel 201 includes a liquid crystal capacitor 110, a storage capacitor 120, a gate line 160, a data line 180, and a transistor 200. The data line 180 couples to a column driver 105 in FIG. 1, and the gate line 160 couples to a row driver 107 in FIG. 1. The transistor 200 has a gate electrode 240 coupled to the gate line 160, a drain electrode 260 coupled to the first end of the crystal liquid capacitor 110, and a source electrode 220 coupled to the data line 180. The first end of the storage capacitor 120 is coupled to the drain electrode 260 of the transistor 200. The second end of the crystal liquid capacitor 110 is coupled to the second end of the storage capacitor 120, and the joint point is called the common electrode, which is supplied by the common voltage “Vcom”. The data line 180 transmits image data of a pixel to the source electrode 220 with “Vd” voltage, and the gate line 160 passes a “Vg” voltage to the gate electrode 240 to switch on the transistor 200 to transfer the data into the storage capacitor 120.

A lot of new studies in the LCD field have developed prosperously such as overdrive functions, dynamic contrast adjustments, independent RGB gamma curve corrections, and PPDS system in which data are converted with cyclic DAC functions and so on. The aforementioned technologies of LCD image processing use a lookup table, which is a data array or a data structure stored in an external or internal memory unit of a timing controller, such as an EEPROM or a flash.

The overdrive function of LCD panels is for shortening the response time of the gray level of an image pixel. It is performed by imposing an excessive voltage to force the liquid crystal of the image pixel to respond rapidly and then lowering the excessive voltage to set the liquid crystal in a correct position. Without the overdrive function, if the current gray level and the previous gray level of the image pixel have a great difference, the response time may be longer than a frame time, and thus the current level becomes unreachable. The overdrive levels are determined according to the previous gray level, the current gray level, and their difference. In practice, the overdrive circuitry intercepts the digital data stream, and then compares the previous gray level with the current gray level to choose an overdrive level from a lookup table accordingly. The aforementioned lookup table is provided either from an internal ROM or an external EEPROM of the timing controller. Moreover, in order to downsize the lookup table, virtually all the information in a large (256*256) table is derived from a much smaller (17*17) table through bi-linearly interpolating between major values. Please refer to FIG. 6. FIG. 6 is the diagram of a 17*17 lookup table, which can be enlarged to 256*256 through bi-linearly interpolating between major values according to the prior art.

The dynamic contrast adjustment comprises a histogram analysis and a color analysis of an input image, a backlight control and a data stretch processes. In a conventional LCD panel, no matter whether a dark image or a bright image is inputted, the backlight of the image always keeps at a fixed percentage with a fixed gamma curve for correction. In such a case, some portions in a bright image will become too bright for a viewer to see, and some portions in a dark image will become too dim for a viewer to distinguish. However according to the dynamic contrast adjustment functions, when an image is inputted, through the histogram analysis and the color analysis, the contrast of brightness and details of the image can be analyzed. Then through the backlight control and the data stretch process, a different percentage of backlight is given corresponding to different gamma curves for an image. These processes make the contrast ratio of an image (the maximum luminance in a frame to the minimum luminance in the frame) improve better even if the backlight of the image was adjusted to less percentage for power saving cause. Here, a lookup table is used for data converting in the dynamic contrast adjustments, and through the data converting, the backlight of an image can be adjusted dimmer, but the contrast ratio in a frame is improved even better.

LVDS (Low Voltage Differential Signal) system for image data transmission was introduced in 1990s and has evolved into RSDS (Reduced Swing Differential Signal) system and PPDS (Point-to-Point Differential Signal) system nowadays. The way of image data transmission in RSDS system is parallel and signals transmitted in RSDS system are single-ended; however in PPDS system, serial and differential. When applied to a large-sized LCD or a high-definition LCD, in which the data stream is excessive and a high-frequency data processing is required, RSDS system loses its odds in too many transmission wires which cause a serious EMI problem and require a multi-layer PCB when compared with PPDS system. The cyclic DAC function is used in PPDS system to transfer parallel 8-bit data to one bit serial at a time with a couple of simple components. Inputted 8-bit analog gamma curve data are approximated by 10-bit digital linear data in the cyclic DAC function and the approximated output voltage derived from the 10-bit linear data can be implemented with the following formula:

$${V}_{out} = {V}_{MIDL} + ( S \cdot {V}_{REFLH} + \overline{S} \cdot {V}_{REFLH} - {V}_{MIDL} ) {\sum }_{n = 0}^{N - 2} \frac{{b}_{n}}{N - n - 1}$$

Where S is the sign bit,

N is total number of bits converted,

bₙ is the bit to be converted.

Please refer to FIG. 3 and FIG. 4. FIG. 3 is a simplified schematic drawing of cyclic DAC functions in the timing controller, and FIG. 4 is a chart of the reference lines for offering the reference voltages to approximate the 8-bit data of the original gamma curve with a 10-bit interpolation method, and the original gamma curve. The cyclic DAC circuitry in a column driver 105 in FIG. 1 is separated into 2 parts: the upper range DACs and the lower range DACs. The reference voltages in FIG. 3 generated by the DAC reference voltage generator 109 in FIG. 1 are offered as 6 voltage levels: a high voltage (V_{REFUH}), a middle voltage (V_{MIDU}), and a low voltage (V_{REFUL}) of the upper range DACs, and a high voltage (V_{REFLH}), a middle voltage (V_{MIDL}), and a low voltage (V_{REFLL}) of the lower range DACs. The high voltage (V_{REFUH}) of the upper range DACs is derived from the maximum voltage of the original positively-polarized gamma curve (shown in FIG. 4), the low voltage (V_{REFUL}) of the upper range DACs is derived from the minimum voltage of the original positively-polarized gamma curve, the middle voltage (V_{MIDU}) is derived from the voltage of the turning point of the original positively-polarized gamma curve; similarly, the high voltage (V_{REFLH}) of the lower range DACs is derived from the maximum voltage of the original negatively-polarized gamma curve, the low voltage (V_{REFLL}) of the lower range DACs is derived from the minimum voltage of the original negatively-polarized gamma curve, the middle voltage (V_{MIDL}) is derived from the voltage of the turning point of the original negatively-polarized gamma curve. And the line with slope A determined by the maximum voltage (V_{REFUH}) and the middle voltage (V_{MIDU}) in the positively-polarized frame, the line with slope B determined by the middle voltage (V_{MIDU}) and the minimum voltage (V_{REFUL}) in the positively-polarized frame, the line with slope C determined by the minimum voltage (V_{REFLL}) and the middle voltage (V_{MIDL}) in the negatively-polarized frame, and the line with slope D determined by the middle voltage (V_{MIDL}) and the maximum voltage (V_{REFUL}) in the negatively-polarized frame offer the reference voltages to approximate the 8-bit data of the gamma curve with a 10-bit interpolation method. The switches and the capacitors shown in FIG. 3 are for adjusting the output voltage determined by the 10-bit interpolation method.

A lookup table stored in an external or internal memory unit of a timing controller is needed for storing the corresponding 10-bit Digital data of the 8-bit Analog gamma curve in the cyclic DAC functions.

The independent RGB gamma curve corrections are widely used in MVA (Multi-domain Vertical Alignment)-related technologies in order to capture accurate colors of an image. Gamma curves of Red, Green, and Blue of a pixel don't exactly have a similar curvature at the same gray level. In fact, for an image of low luminance, the relative lower gray level of Blue gives a bluish image, that is the so-called “the color shift”—the lower gray, the bluer gray. The independent RGB gamma curve corrections are the Red, Green, and Blue portions of a pixel having an independent gamma curve respectively for reducing the color shift. A lookup table here is used for storing data for independent RGB gamma curves of each pixel according to the gray scale of the inputted image.

From the above, a lookup table is used for replacing a runtime computation to offer data in a timing controller, and a memory unit used for storing lookup tables is a basic component of the timing controller in an LCD panel. In conventional technologies, the memory unit is often disposed outside the timing controller, which makes a larger space needed on PCB, longer data transmission time, and more complicate PCB layout.

### SUMMARY OF THE INVENTION

According to an embodiment of the present invention, a timing controller for processing image data comprises a programmable nonvolatile memory, a receiver, a processor, and a transmitter. The programmable nonvolatile memory in the timing controller is for storing lookup tables. The receiver in the timing controller is for receiving data. The processor coupled to the receiver is for processing the data according to the lookup tables. And the transmitter coupled to the processor is for transmitting data generated from the processor to column drivers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the structure of an LCD according to the prior art.

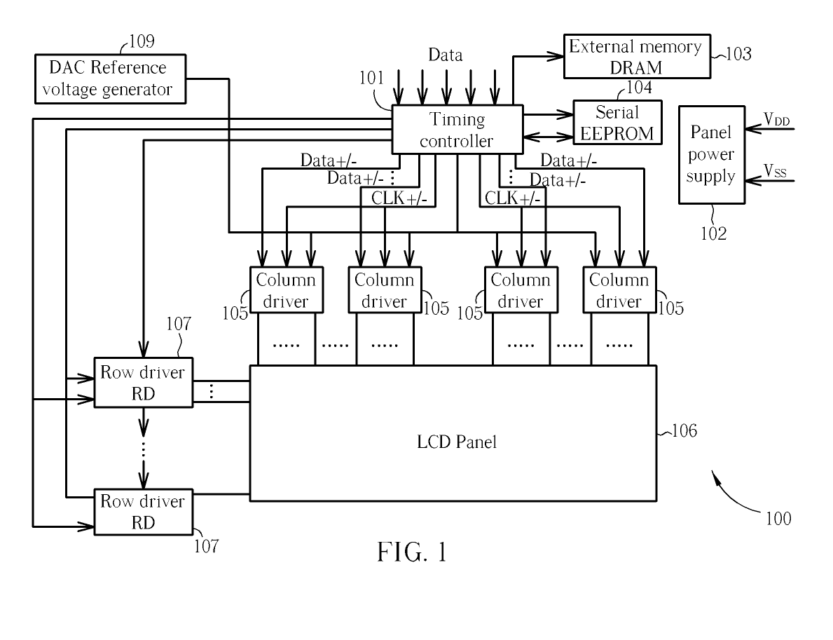

FIG. 2 is a schematic drawing of a pixel according to the prior art.

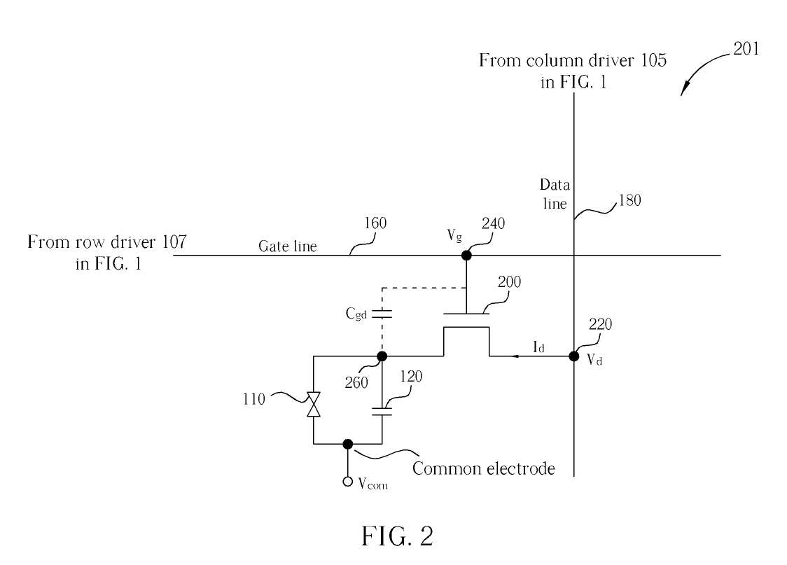

FIG. 3 is a simplified schematic drawing of cyclic DAC functions in the timing controller according to the prior art.

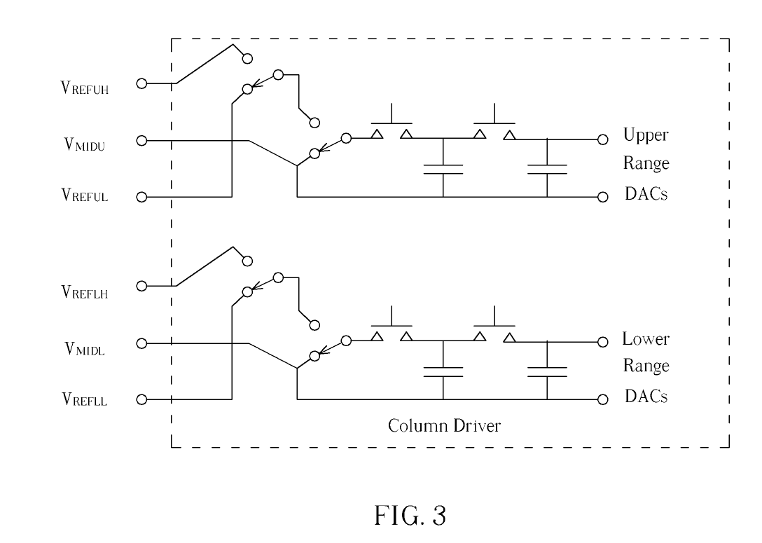

FIG. 4 is a chart of the reference lines for offering the reference voltages to approximate the original gamma curve with an interpolation method, and the original gamma curve according to the cyclic DAC function of the prior art.

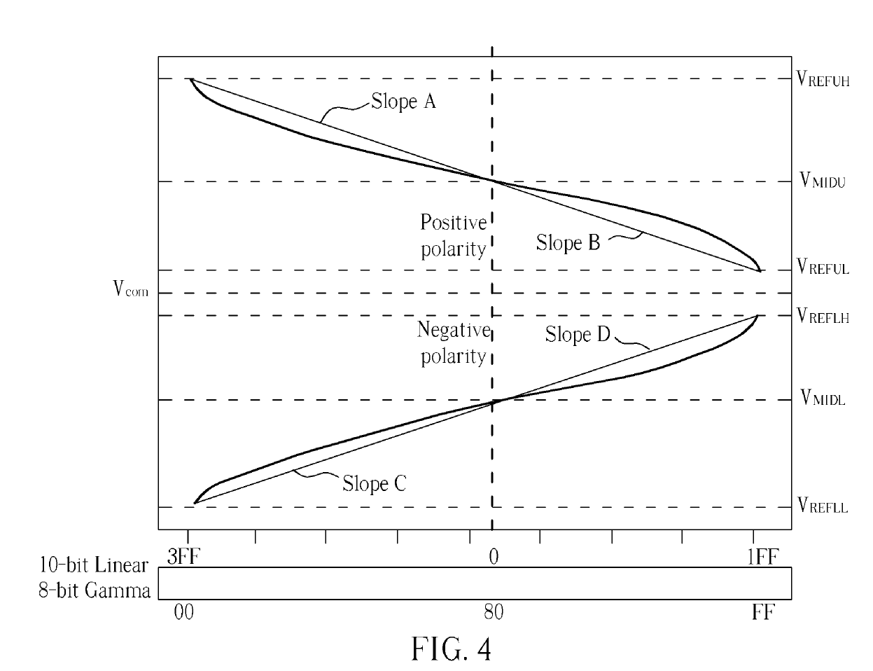

FIG. 5 is a block diagram of overdrive function and independent RGB gamma curve corrections in a timing controller according to the present invention.

FIG. 6 is a diagram of a 17*17 lookup table, which can be enlarged to 256*256 through bi-linearly interpolating between major values according to the prior art.

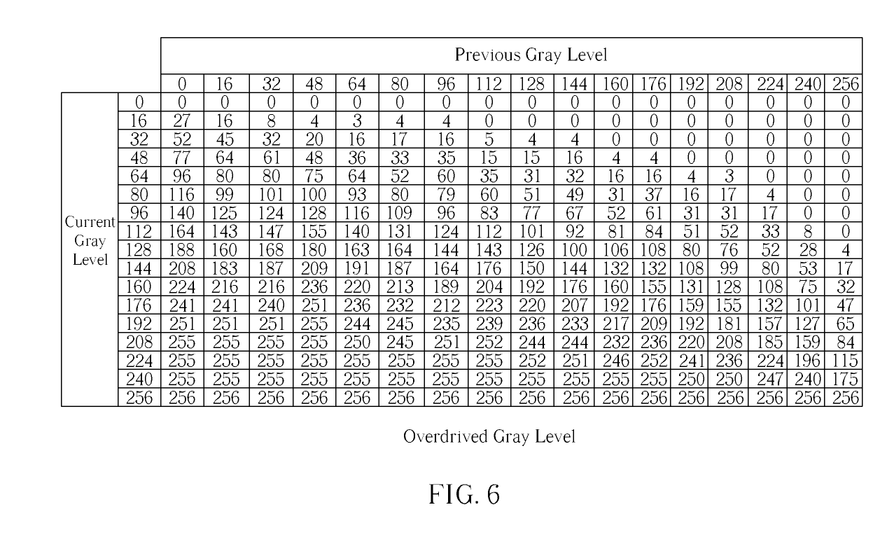

FIG. 7 is a block diagram of dynamic contrast adjustments in the timing controller in FIG. 5.

FIG. 8 is a block diagram of data conversion for cyclic DAC functions in the timing controller in FIG. 5.

### DETAILED DESCRIPTION

The present invention combines the timing controller with an internal OTP memory (one time programmable nonvolatile memory) or MTP memory (multiple time programmable nonvolatile memory) for storing lookup tables. The main advantage of the present invention is that the logic process of the OTP memory and the logic process of the timing controller are completely compatible, no additional logic process should be added, and the logic process of the MTP memory only needs two or three photomask processes more than the logic process of the timing controller.

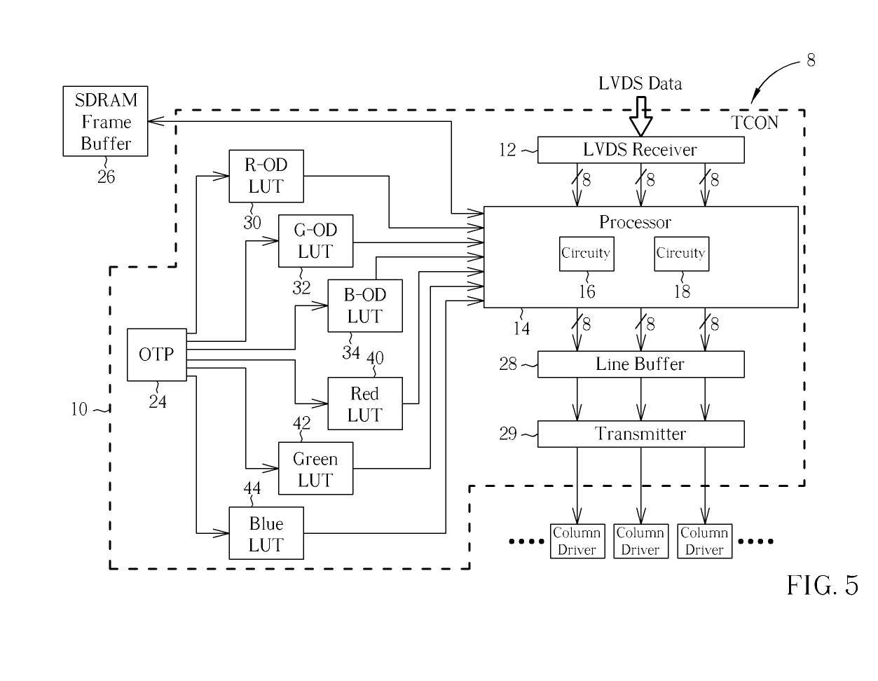

Please refer to FIG. 5. FIG. 5 is a block diagram of overdrive functions and independent RGB gamma curve corrections in a timing controller 8 according to the present invention. The timing controller 8 includes an LVDS receiver 12, a processor 14 with circuitry 16 and 18, an OTP memory 24 as a memory unit, an R-ODLUT unit 30, a G-ODLUT unit 32, a B-ODLUT unit 34, a RedLUT unit 40, a GreenLUT unit 42, a BlueLUT unit 44, a line buffer 28, and a transmitter 29. First LVDS data of the present image are received by the LVDS receiver 12 and then sent to the processor 14 with circuitry 16 for processing the overdrive functions. The circuitry 16 of the processor 14 compares the previous image stored in an external SDRAM frame buffer 26 with the inputted present image. According to the compared results, the red portion of the overdrived gray level is chosen from the R-ODLUT unit 30, the green portion of the overdrived gray level is chosen from the G-ODLUT unit 32, and the blue portion of the overdrived gray level is chosen from the B-ODLUT unit 34 respectively. A lookup table stored in the OTP memory 24 provides RGB gray levels and sends to the R-ODLUT unit 30, the G-ODLUT unit 32, and the B-ODLUT unit 34 for access by the circuitry 16 of the processor 14. After overdrived, the circuitry 18 of the processor 14 deals the RGB data transmitted from the circuitry 16 of the processor 14 with the independent RGB gamma curve corrections. An independent Red gamma curve of a pixel is sent from the RedLUT unit 40, an independent Green gamma curve of the pixel is sent from the GreenLUT unit 42, and an independent Blue gamma curve of a pixel is sent from the BlueLUT unit 44 to the circuitry 18 of the processor 14 to provide independent RGB gamma curves for correction according to the gray level of the pixel. The lookup table of independent RGB gamma curves of each pixel is also stored in the OTP memory 24 and sent to the RedLUT unit 40, the GreenLUT unit 42, and the BlueLUT unit 44 respectively for access. At last, the adjusted RGB data of the image are sent to the line buffer 28 and then transmitted to the transmitter 29 in parallel for outputting to column drivers to drive pixels of an LCD panel.

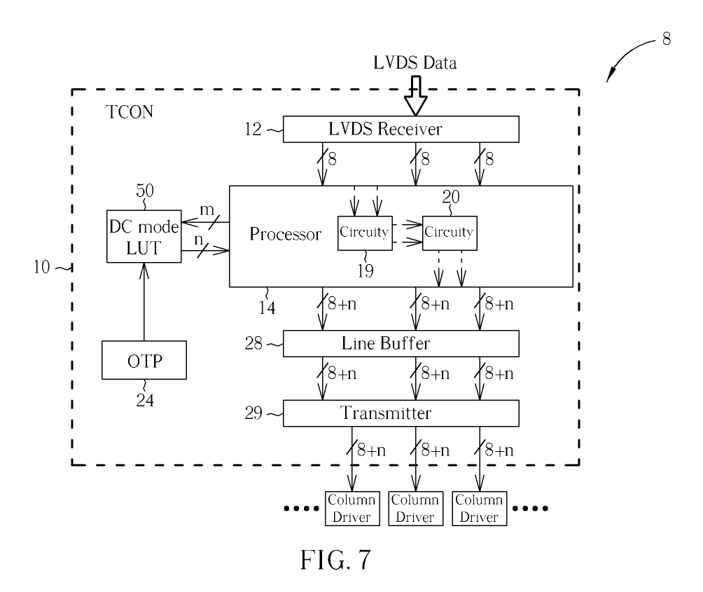

Please refer to FIG. 7. FIG. 7 is a block diagram of dynamic contrast adjustments in the timing controller 8 according to the present invention. The timing controller 8 includes the LVDS receiver 12, the processor 14 with circuitry 19 and 20, the OTP memory 24 as the memory unit, a DC-mode-LUT 50, the line buffer 28, and the transmitter 29. First 8-bit LVDS data of the present image are received from the LVDS receiver 12 and then sent to the processor 14 with circuitry 19 and 20 for processing dynamic contrast adjustments. The image analysis circuitry 19 of the processor 14 performs histogram analysis and color analysis on the inputted LVDS data to generate m-bit data of the analyzed results. The analyzed results are transmitted to the DC-mode-LUT 50 and the inputted 8-bit data are forwarded to the synthesizing data circuitry 20 of the processor 14. According to the analyzed result transmitted to the DC-mode-LUT 50, n-bit data for the dynamic contrast adjustments are chosen from a lookup table stored in the OTP memory 24 to add in the synthesizing data circuitry 20. Combined the relative n-bit data with the 8-bit data, (8+n)-bit data for adjusting the backlight of the image with a relative gamma curve for better luminance contrast and for low power dissipation are sent out from the synthesizing data circuitry 20 of the processor 14 to the line buffer 28. At last, the transmitter 29 receives the (8+n)-bit data from the line buffer 28 and outputs in parallel to external column drivers to drive pixels of an LCD panel.

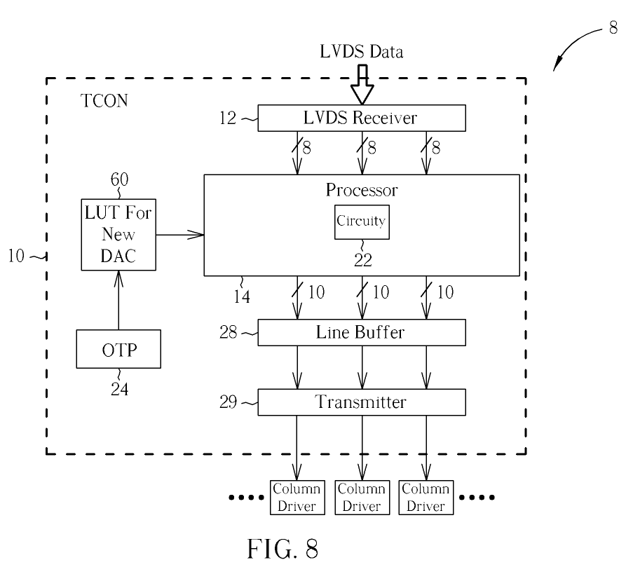

Please refer to FIG. 8. FIG. 8 is a block diagram of data conversion for cyclic DAC functions in the timing controller 8 according to the present invention. The timing controller 8 includes the LVDS receiver 12, the processor 14 with circuitry 22, the OTP memory 24 as the memory unit, a LUT for new DAC 60, the line buffer 28, and the transmitter 29. First LVDS data of the present image are received from the LVDS receiver 12 and then sent to the processor 14 with circuitry 22 for data conversion of cyclic DAC functions. The circuitry 22 of the processor 14 approximates the 8-bit analog gamma curve with 10-bit digital linear data from a lookup table accessed from the LUT for new DAC 60, then outputs the chosen 10-bit data to the line buffer 28 for forwarding to the transmitter 29 in sequence to output to column drivers to drive pixels of an LCD panel. The lookup table for data conversion (from 8-bit analog gamma curve to 10-bit digital linear data) is stored in the OTP memory 24 and then sent to the LUT for new DAC 60 for access.

In above contents, the OTP memory is replaceable by the MTP memory to meet multi-time programmable needs of the user. To sum up, the present invention integrates an external memory into the timing controller with no additional logic process added for one time programmable nonvolatile memory or with two or three additional photomask processes for multiple time programmable nonvolatile memory, and can reduce the size of a system board, data-transmission speed, and the complexity of the PCB design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A timing controller for processing image data comprising:
a programmable nonvolatile memory in the timing controller for storing lookup tables;
a receiver in the timing controller for receiving data;
a processor coupled to the receiver for processing the data according to the lookup tables; and
a transmitter coupled to the processor for transmitting data generated from the processor to column drivers.

2. The timing controller of claim 1 wherein the memory is a one time programmable nonvolatile memory.

3. The timing controller of claim 2 wherein a logic process of the one time programmable nonvolatile memory is compatible with a logic process of the timing controller.

4. The timing controller of claim 1 wherein the memory is a multiple time programmable nonvolatile memory.

5. The timing controller of claim 4 wherein a logic process of the multiple time programmable nonvolatile memory needs no more than 3 photomask processes than the logic process of the timing controller.

6. The timing controller of claim 1 wherein lookup tables comprise a set of numbers describing overdrive functions, dynamic contrast adjustments, independent RGB Gamma curve corrections, or data conversion of cyclic DAC functions.

7. The timing controller of claim 6 wherein the processor performs overdrive functions according to the lookup table of overdrive functions.

8. The timing controller of claim 6 wherein the processor performs dynamic contrast adjustments according to the lookup table of dynamic contrast adjustments.

9. The timing controller of claim 6 wherein the processor performs independent RGB Gamma curve corrections according to the lookup table of independent RGB Gamma curve corrections.

10. The timing controller of claim 6 wherein the processor performs data conversion of cyclic DAC functions according to the lookup table of cyclic DAC functions.

11. The timing controller of claim 1 further comprises a line buffer coupled to the processor for storing data generated by the processor temporarily.
